(19) United States
(12) Patent Application Publication
(10) Pub. No.: US 2013/0345327 A1
(43) Pub. Date: Dec. 26, 2013

(54) PROCESS FOR PRODUCING EXPANDABLE PELLETIZED MATERIAL WHICH COMPRISES POLYLACTIC ACID

(71) Applicant: BASF SE, Ludwigshafen (DE)

(72) Inventors: Jerome Lohmann, Landau (DE); Bangaru Dharmapuri Sriramulu Sampath, Ludwigshafen (DE); Peter Gutmann, Karlsruhe (DE); Andreas Künkel, Neustadt (DE); Klaus Hahn, Kirchheim (DE); Andreas FüßI, Heidelberg (DE)

(21) Appl. No.: 13/926,252

(22) Filed: Jun. 25, 2013

Related U.S. Application Data
(60) Provisional application No. 61/664,196, filed on Jun. 26, 2012.

(51) Int. Cl. C08J 9/16

(52) U.S. Cl. CPC C08J 9/16
USPC 521/59; 264/50

(57) ABSTRACT

The invention relates to a process for producing expandable pelletized material which comprises polylactic acid which comprises the following steps:
a) melting and incorporation by mixing of the following components: i) from 61.9 to 98.9% by weight, based on the total weight of components i to iv, of polylactic acid, ii) from 1 to 38% by weight, based on the total weight of components i to iv, of at least one polyhydroxyalkanoate, iii) from 0 to 30% by weight, based on the total weight of components i to iv, of at least one polyester based on aliphatic and/or aromatic dicarboxylic acids and on aliphatic dihydroxy compounds; iv) from 0.1 to 2% by weight, based on the total weight of components i to iv, of a copolymer which comprises epoxy groups and which is based on styrene, acrylate, and/or methacrylate, and v) from 0 to 10% by weight, based on the total weight of components i to v, of one or more additives,
b) incorporation by mixing of vi) from 3 to 7% by weight, based on the components i to v) of an organic blowing agent into the polymer melt by means of a static or dynamic mixer at a temperature of at least 140° C.,
c) discharging through a die plate with holes, the diameter of which at the exit from the die is at most 1.5 mm, and
d) pelletizing the melt comprising blowing agent directly downstream of the die plate, and under water, at a pressure in the range from 1 to 30 bar.

The invention relates to a process for producing expandable pelletized material which comprises polylactic acid which comprises the following steps:
a) melting and incorporation by mixing of the following components: i) from 61.9 to 98.9% by weight, based on the total weight of components i to iv, of polylactic acid, ii) from 1 to 38% by weight, based on the total weight of components i to iv, of at least one polyhydroxyalkanoate, iii) from 0 to 30% by weight, based on the total weight of components i to iv, of at least one polyester based on aliphatic and/or aromatic dicarboxylic acids and on aliphatic dihydroxy compounds; iv) from 0.1 to 2% by weight, based on the total weight of components i to iv, of a copolymer which comprises epoxy groups and which is based on styrene, acrylate, and/or methacrylate, and v) from 0 to 10% by weight, based on the total weight of components i to v, of one or more additives,
b) incorporation by mixing of vi) from 3 to 7% by weight, based on the components i to v) of an organic blowing agent into the polymer melt by means of a static or dynamic mixer at a temperature of at least 140° C.,
c) discharging through a die plate with holes, the diameter of which at the exit from the die is at most 1.5 mm, and
d) pelletizing the melt comprising blowing agent directly downstream of the die plate, and under water, at a pressure in the range from 1 to 30 bar.

The invention further relates to expandable pelletized material which comprises polylactic acid and which is obtainable by said process, and also to specific expandable pelletized material which comprises polylactic acid and which has a proportion of from 3 to 7% by weight of an organic blowing agent, preferably isopentane. The invention further relates to a preferred process for producing expandable pelletized material which comprises blowing agent and which comprises polylactic acid, via underwater pelletization at low temperatures and, respectively, with use of an inert co-blowing agent. Finally, the invention relates to (expandable) pelletized material which comprises blowing agent and which is obtainable by means of the above-mentioned process.

WO 01/012706 and WO 2011/086030 disclose processes for producing expandable pelletized material which comprises, alongside polylactic acid, an aliphatic-aromatic polyester. However, this pelletized material is not always entirely satisfactory in respect of degradation under anaerobic conditions.

The literature does not describe any expandable pelletized material which comprises polylactic acid and which comprises polyhydroxyalkanoates (component ii). Although EP 2168993 discloses expanded moldable foams, these are based on compounded materials which comprise about 70 to 80% by weight of polyhydroxyalkanoate and only from 20 to 30% by weight of polylactic acid. In order to obtain moldable foams with acceptable densities, amounts of some percent of a polyurethane compound have to be added to the compounded materials prior to the foaming process, and this in turn has an adverse effect on biodegradability. That process cannot moreover exclude premature foaming of the pelletized material.

It was an object of the present invention to provide a simple process which can give good results in producing expandable pelletized material which comprises polylactic acid and, and which degrades extremely well under both anaerobic and aerobic conditions.

The process described in the introduction has accordingly been found.

The process of the invention is described in more detail below.

The mixture which comprises polylactic acid and which is used in stage a) is generally composed of:
i) from 61.9 to 98.9% by weight, based on the total weight of components i to iv, of polylactic acid,
ii) from 1 to 38% by weight, based on the total weight of components i to iv, of at least one polyhydroxyalkanoate,
iii) from 0 to 30% by weight, based on the total weight of components i to iv, of at least one polyester based on aliphatic and/or aromatic dicarboxylic acids and on aliphatic dihydroxy compounds,
iv) from 0.1 to 2% by weight, based on the total weight of components i to iv, of a copolymer which comprises epoxy groups and which is based on styrene, acrylate, and/or methacrylate, and
v) from 0 to 10% by weight, based on the total weight of components i to v, of one or more additives;

It is preferable that the mixture which comprises polylactic acid is composed of
i) from 65 to 95% by weight, particularly from 70 to 90% by weight based on the total weight of components i to iv, of polylactic acid,
ii) from 1 to 38% by weight, particularly from 10 to 30% by weight, based on the total weight of components i to iv, of at least one polyhydroxyalkanoate,
iii) from 0 to 30% by weight, particularly from 5 to 20% by weight based on the total weight of components i to iv, of at least one polyester based on aliphatic dicarboxylic acids and on aliphatic dihydroxy compounds or derived from polyalkylene succinate-co-terephthalate,
v) from 0.1 to 2% by weight, in particular from 0.1 to 1% by weight based on the total weight of components i to iv, of a copolymer which comprises epoxy groups and which is based on styrene, acrylate, and/or methacrylate, and
v) from 0.1 to 2% by weight, based on the total weight of components i to v, of a nucleating agent.

Component i) preferably comprises polylactic acid with the following property profile:
melt volume rate of from 0.5 to 15 ml/10 minutes, preferably from 1 to 9 ml/10 minutes, particularly preferably from 5 to 8 ml/10 minutes (MVR at 190° C. using 2.16 kg to ISO 1133)
melting point below 180° C.
glass transition temperature (Tg) above 40° C.
water content smaller than 1000 ppm
residual monomer content (lactide) smaller than 0.3%
molecular weight greater than 50 000 daltons.

Examples of preferred polylactic acids are the following from NatureWorks®:

Ingeo® 2002 D, 4032 D, 4042 D and 4043 D, 8251 D, 3251 D, and in particular 8051 D and 8052D. NatureWorks 8051 D and 8052 D are polylactic acids from NatureWorks, where the properties of the products are as follows: Tg: 65.3° C., Tm: 153.9° C., MVR: 6.9 [ml/10 minutes], M_{w}:186000, Mn:107000. Said products moreover have a slightly higher acid number.

Polylactic acids that have proven particularly advantageous for producing the expandable pelletized material of the invention have MVR of from 5 to 8 ml/10 minutes to ISO 1133 [190° C./2.16 kg].

Polylactic acids which are particularly suitable have the abovementioned MVR range and/or have a low-temperature-crystallization onset temperature in the range from 80° C. to 125° C., preferably from 90° C. to 115° C., and particularly preferably from 95° C. to 105° C., measured by means of DSC (differential scanning calorimetry) at a heating rate of 20K/min (measurement range from −60° C. to 22° C.; Mettler DSC 30 using a TC15/TA controller, Mettler-Toledo AG).

It has been found that under the abovementioned conditions most of the types of polylactic acid obtainable on the market have a low-temperature-crystallization onset temperature below 80° C. Comparison of NatureWorks® 8051D, 8052 D, and 4042D polylactic acids (PLAs) will clearly show (see table) the different crystallization behavior of the pelletized material produced therefrom. The table shows DSC measurements on expandable pelletized material from two types of PLA, which were respectively nucleated with 0.3% by weight of talc and charged with 5.7% by weight of n-pentane as blowing agent.

TABLE
DSC data for a heating rate of 20K/min (measurement
range from −60° C. to 220° C.)

| | Tg (glass | | Tc (low- | Tm |
|---|---|---|---|---|
| | transition | | temperature | (melting |
| Example | temp.) | Tc onset | cryst.) | point) |
| PLA 4042 D | 42.4° C. | 71.8° C. | 82.5° C. | 155.6° C. |
| PLA 8051 D | 41.1° C. | 94.7° C. | 106.9° C. | 147.6° C. |

The crystalline content of the expandable pelletized material after the production process is generally only a few percent; the material is therefore predominantly amorphous. A higher low-temperature-crystallization onset temperature in the region of 8° C. to 125° C., preferably from 90° C. to 115° C., and particularly preferably from 95° C. to 105° C., favors foaming by steam. Types of PLAs such as NatureWorks® 8051D and 8052D provide an ideal balance between tendency towards crystallization and foaming behavior in the expandable pelletized material.

Polyhydroxyalkanoates (component ii) are primarily poly-4-hydroxybutyrates and poly-3-hydroxybutyrates and copolyesters of the abovementioned polyhydroxybutyrates with 3-hydroxyvalerate, 3-hydroxyhexanoate and/or 3-hydroxyoctanoate. Poly-3-hydroxybutyrates are marketed by way of example by PHB Industrial with trademark Biocycle® and by Tianan with trademark Enmat®.

Poly-3-hydroxybutyrate-co-4-hydroxybutyrates are in particular known by Metabolix. They are marketed with trademark Mirel®.

Poly-3-hydroxybutyrate-co-3-hydroxyhexanoates are by way of example known from Kaneka. Poly-3-hydroxybutyrate-co-3-hydroxyhexanoates generally have from 1 to 20 mol % content of 3-hydroxyhexanoate and preferably from 3 to 15 mol %, based on component ii. Particular preference is given to content of from 10 to 13 mol % of 3-hydroxyhexanoate. Poly-3-hydroxybutyrate-co-3-hydroxyhexanoates are particularly preferred for the moldable foams of the invention.

The molecular weight Mw of the polyhydroxyalkanoates is generally from 100 000 to 1 000 000, and preferably from 300 000 to 600 000.

Component iii is aliphatic or semiaromatic (aliphatic-aromatic) polyesters.

As mentioned, purely aliphatic polyesters are suitable as component iii). Aliphatic polyesters are polyesters derived from aliphatic C₂-C₁₂ alkanediols and from aliphatic C₄-C₃₆ alkanedicarboxylic acids, e.g. polybutylene succinate (PBS), polybutylene adipate (PBA), polybutylene succinate adipate (PBSA), polybutylene succinate sebacate (PBSSe), polybutylene sebacate adipate (PBSeA), polybutylene sebacate (PBSe), or corresponding polyesteramides. The aliphatic polyesters are marketed by Showa Highpolymers as Bionolle, and by Mitsubishi as GSPIa. WO 2010/034711 describes relatively recent developments.

The intrinsic viscosities of the aliphatic polyesters are generally from 150 to 320 cm³/g and preferably from 150 to 250 cm³/g, to DIN 53728.

MVR (melt volume rate) is generally from 0.1 to 70 cm/10 min., preferably from 0.8 to 70 cm³/10 min., and in particular from 1 to 60 cm³/10 min., to EN ISO 1133 (190° C., 2.16 kg weight).

Acid numbers are generally from 0.01 to 1.2 mg KOH/g, preferably from 0.01 to 1.0 mg KOH/g, and particularly preferably from 0.01 to 0.7 mg KOH/g, to DIN EN 12634.

Semiaromatic polyesters, which are likewise suitable as component iii), are composed of aliphatic diols and of aliphatic, and also aromatic, dicarboxylic acids. Among the suitable semiaromatic polyesters are linear non-chain-extended polyesters (WO 92/09654). Particularly suitable partners in a mixture are aliphatic/aromatic polyesters derived from butanediol, from terephthalic acid, and from aliphatic C₄-C₁₈ dicarboxylic acids, such as succinic acid, glutaric acid, adipic acid, suberic acid, azelaic acid, sebacic acid, and brassylic acid (for example as described in WO 2006/097353 to 56). It is preferable to use chain-extended and/or branched semiaromatic polyesters as component iii. The latter are known from the following specifications mentioned in the introduction: WO 96/15173 to 15176. 21689 to 21692, 25446, 25448 or from WO 98/12242, expressly incorporated herein by way of reference. It is also possible to use a mixture of different semiaromatic polyesters.

Biodegradable, aliphatic-aromatic polyesters iii are particularly suitable for the process of the invention for producing moldable foams, where these polyesters comprise:
a) from 40 to 70 mol %, based on components a to b, of one or more dicarboxylic acid derivatives or dicarboxylic acids selected from the group consisting of: succinic acid, adipic acid, sebacic acid, azelaic acid, and brassylic acid;
b) from 60 to 30 mol %, based on components a to b, of a terephthalic acid derivative;
c) from 98 to 102 mol %, based on components a to b, of a C₂-C₈ alkylenediol or C₂-C₆ oxyalkylenediol;
d) from 0.00 to 2% by weight, based on the total weight of components a to c, of a chain extender and/or crosslinking agent selected from the group consisting of: a di- or polyfunctional isocyanate, isocyanurate, oxazoline, epoxide, peroxide, and carboxylic anhydride, and/or an at least trihydric alcohol, or an at least tribasic carboxylic acid.

Aliphatic-aromatic polyesters iii used with preference comprise:
a) from 50 to 65 mol %, and in particular 58 mol % based on components a to b, of one or more dicarboxylic acid derivatives or dicarboxylic acids selected from the group consisting of: succinic acid, azelaic acid, brassylic acid, and preferably adipic acid, particularly preferably sebacic acid;
b) from 50 to 35 mol %, and in particular 42 mol % based on components a to b, of a terephthalic acid derivative;
c) from 98 to 102 mol %, based on components a to b, of 1,4-butanediol, and
d) from 0 to 2% by weight, preferably from 0.01 to 2% by weight, based on the total weight of components a to c, of a chain extender and/or crosslinking agent selected from the group consisting of: a polyfunctional isocyanate, isocyanurate, oxazoline, carboxylic anhydride, such as maleic anhydride, or epoxide (in particular an epoxidized poly(meth)acrylate), and/or an at least trihydric alcohol, or an at least tribasic carboxylic acid.

Aliphatic dicarboxylic acids that are preferably suitable are succinic acid, adipic acid, and with particular preference sebacic acid. An advantage of polyesters which comprise succinic acid and which comprise sebacic acid are that they are also available in the form of renewable raw material.

Polyesters iii preferably used comprise:
a) from 90 to 99.5 mol %, based on components a to b, of succinic acid;
b) from 0.5 to 10 mol %, based on components a to b, of one or more C₈-C₂₀ dicarboxylic acids
c) from 98 to 102 mol %, based on components a to b, of 1,3-propanediol or 1,4-butanediol.

Polyesters iii particularly preferably used comprise:
a) from 90 to 99.5 mol %, based on components a to b, of succinic acid;
b) from 0.5 to 10 mol %, based on components a to b, of terephthalic acid, azelaic acid, sebacic acid, and/or brassylic acid
c) from 98 to 102 mol %, based on components a to b, of 1,3-propanediol or 1,4-butanediol, and
d) from 0.01 to 5% by weight, based on the total weight of components a to c, of a chain extender and/or crosslinking agent selected from the group consisting of: a polyfunctional isocyanate, isocyanurate, oxazoline, epoxide (in particular an epoxidized poly(meth)acrylate), an at least trihydric alcohol, or an at least tribasic carboxylic acid.

The number-average molar mass (Mn) of the polyesters iii is generally in the range from 5000 to 100 000 g/mol, in particular in the range from 10 000 to 75 000 g/mol, preferably in the range from 15 000 to 38 000 g/mol, while their weight-average molar mass (Mw) is generally from 30 000 to 300 000 g/mol, preferably from 60 000 to 200 000 g/mol, and their Mw/Mn ratio is from 1 to 6, preferably from 2 to 4. Intrinsic viscosity is from 50 to 450 g/ml, preferably from 80 to 250 g/ml (measured in o-dichlorobenzene/phenol (ratio by weight 50/50)). The melting point is in the range from 85 to 150° C., preferably in the range from 95 to 140° C.

The polyesters mentioned can have hydroxy and/or carboxy end groups in any desired ratio. The semiaromatic polyesters mentioned can also be end-group-modified. By way of example, therefore, OH end groups can be acid-modified via reaction with phthalic acid, phthalic anhydride, trimellitic acid, trimellitic anhydride, pyromellitic acid, or pyromellitic anhydride. Preference is given to polyesters having acid numbers smaller than 1.5 mg KOH/g.

Component iv) is described in more detail below.

Epoxides are in particular a copolymer which is based on styrene, acrylate, and/or methacrylate, and which contains epoxy groups. The units bearing epoxy groups are preferably glycidyl (meth)acrylates. Copolymers that have proven advantageous have a proportion of glycidyl methacrylate greater than 20% by weight, particularly preferably greater than 30% by weight, and with particular preference greater than 50% by weight, based on the copolymer. The epoxide equivalent weight (EEW) in these polymers is preferably from 150 to 3000 g/equivalent and with particular preference from 200 to 500 g/equivalent. The average molecular weight (weight average) M_{w} of the polymers is preferably from 2000 to 25 000, in particular from 3000 to 8000. The average molecular weight (number average) Mₙ of the polymers is preferably from 400 to 6000, in particular from 1000 to 4000. Polydispersity (Q) is generally from 1.5 to 5. Copolymers of the abovementioned type containing epoxy groups are marketed by way of example by BASF Resins B.V. as Joncryl® ADR. Joncryl® ADR 4368 is particularly suitable as component iv).

Component v is in particular one or more of the following additives: stabilizer, nucleating agent, lubricant and release agent, such as stearates (in particular calcium stearate); plasticizer, such as citric ester (in particular tributyl acetylcitrate), glycerol esters, such as triacetylglycerol, or ethylene glycol derivatives, surfactants, such as polysorbates, palmitates, or laurates; waxes, such as beeswax or beeswax esters, antistatic agent, UV absorbers; UV stabilizers; antifogging agents, dyes, fillers, or other plastics additives. The concentrations used of the additives are from 0 to 10% by weight, in particular from 0.1 to 2% by weight, based on the polyesters of the invention. It is particularly preferable as mentioned above to use from 0.5 to 1% by weight, based on components i to v, of a nucleating agent.

Nucleating agent is in particular talc, chalk, carbon black, graphite, calcium stearate or zinc stearate, poly-D-lactic acid, N,N′-ethylenebis-12-hydroxystearamide, or polyglycolic acid. Talc is particularly preferred as nucleating agent.

The blowing agent can be interpreted as further component vi.

The polymer melt comprising blowing agent generally comprises a total proportion of from 3 to 7% by weight, based on the polymer melt comprising blowing agent, of one or more blowing agents homogeneously dispersed. When co-blowing agents vii are used, it is also possible to use less than 3% by weight of blowing agent vi. Suitable blowing agents are the physical blowing agents conventionally used in EPS, e.g. aliphatic hydrocarbons having 2 to 7 carbon atoms, alcohols, ketones, ethers, amides, or halogenated hydrocarbons. It is preferable to use isobutane, n-butane, n-pentane, and in particular isopentane. Preference is further given to mixtures of n-pentane and isopentane, and of n-butane and isopentane.

The amount added of blowing agent is selected in such a way that the expansion capability a of the expandable pelletized material, defined as bulk density prior to the pre-foaming process, is from 500 to 800 kg/m³, preferably from 580 to 800 kg/m³, and that their bulk density after the pre-foaming process is at most 125 kg/m³, preferably from 8 to 100 kg/m³.

When fillers are used, bulk densities in the range from 590 to 1200 kg/m³ can arise as a function of the nature and amount of the filler.

To produce the expandable pelletized material of the invention, the blowing agent is incorporated by mixing into the polymer melt. The process comprises the following stages: a) production of melt, b) mixing, c) conveying, and d) pelletizing. Each of said stages can be executed by the apparatuses or apparatus combinations known in plastics processing. For the incorporation-by-mixing process, static or dynamic mixers are suitable, examples being extruders. The polymer melt can be produced directly via melting of pelletized polymer material. If necessary, the temperature of the melt can be lowered by using a cooler. Examples of methods that can be used for pelletizing are pressurized underwater pelletization, and pelletization using rotating knives and spray-mist cooling by temperature-control liquids. Examples of suitable arrangements of apparatus for conducting the process are:
i) extruder-static mixer-cooler-pelletizer
ii) extruder-pelletizer.

The arrangement can moreover have an ancillary extruder for introducing additives, e.g. solids or additional materials that are heat-sensitive.

The temperature at which the polymer melt comprising blowing agent is conveyed through the die plate is generally in the range from 140 to 300° C., preferably in the range from 160 to 240° C.

The die plate is heated at least to the temperature of the polymer melt comprising blowing agent. It is preferable that the temperature of the die plate is in the range from 20 to 100° C. above the temperature of the polymer melt comprising blowing agent. This inhibits formation of polymer deposits within the dies and ensures that pelletization is problem-free.

In order to obtain marketable pellet sizes, the diameter (D) of the die holes at the exit from the die should be in the range from 0.1 to 2 mm, preferably in the range from 0.1 to 1.2 mm, particularly preferably in the range from 0.1 to 0.8 mm. Even after die swell, this permits controlled setting of pellet sizes below 2 mm, in particular in the range from 0.2 to 1.4 mm.

Die swell can be affected not only by molecular-weight distribution but also by the geometry of the die. The die plate preferably has holes with an L/D ratio of at least 2, where the length (L) corresponds to that region of the die where the diameter is at most the diameter (D) at the exit from the die. The L/D ratio is preferably in the range from 3 to 20.

The diameter (E) of the holes at the entry to the die plate should generally be at least twice as large as the diameter (D) at the exit from the die.

One embodiment of the die plate has holes with conical inlet and an inlet angle α smaller than 180°, preferably in the range from 30 to 120°. In another embodiment, the die plate has holes with a conical outlet and an outlet angle β smaller than 90°, preferably in the range from 15 to 45°. In order to produce controlled pellet size distributions in the polymers, the die plate may be equipped with holes of different discharge diameter (D). The various embodiments of die geometry can also be combined with one another.

One preferred process for producing expandable pelletized material which comprises polylactic acid comprises the following steps:
a) melting and incorporation by mixing of components i) from 61.9 to 98.9% by weight based on the total weight of components i to iv, of polylactic acid, ii) from 1 to 38% by weight, based on the total weight of components i to iv, of at least one polyhydroxyalkanoate, iii) from 0 to 30% by weight, based on the total weight of components i to iv, of at least one polyester based on aliphatic and/or aromatic dicarboxylic acids and on aliphatic dihydroxy compounds; iv) from 0.1 to 2% by weight, based on the total weight of components i to iv, of a copolymer which comprises epoxy groups and which is based on styrene, acrylate, and/or methacrylate, and v) from 0 to 10% by weight, based on the total weight of components i to v, of one or more additives,
b) incorporation by mixing of an organic blowing agent into the polymer melt optionally by means of a static or dynamic mixer at a temperature of at least 140° C., preferably from 180 to 260° C., and optionally cooling of the polymer melt comprising blowing agent to a temperature of from 120 to 160° C. by means of an intervening cooling apparatus, prior to discharge,
c) discharging through a die plate with holes, the diameter of which at the exit from the die is at most 1.5 mm, and
d) pelletizing the melt comprising blowing agent directly downstream of the die plate, and under water, at a pressure in the range from 1 to 20 bar.

It has moreover been found that a reduction in the temperature down to from 5 to 20° C. during the underwater pelletization process gives expandable pelletized materials which comprise polylactic acid and which have defined cavities with an average diameter in the range from 0.1 to 50 μm. The average diameter of the pelletized materials is generally in the range from 0.1 to 2 mm, and they have from 50 to 300 cavities/mm² of cross-sectional area. The temperature reduction during the underwater pelletization process can reduce bulk density to the range from 580 to 800 kg/m³, and preferably 580 to 720 kg/m³. The resultant expandable pelletized materials which comprise polylactic acid moreover have increased storage stability. They can be foamed without difficulty even after a period of weeks.

The reduction of bulk density and increase of storage stability for the expandable pelletized materials which comprise polylactic acid can also be achieved by using the following preferred procedure:
a) i) from 61.9 to 98.9% by weight, based on the total weight of components i to iv, of polylactic acid, ii) from 1 to 38% by weight, based on the total weight of components i to iv, of at least one polyhydroxyalkanoate, iii) from 0 to 30% by weight, based on the total weight of components i to iv, of at least one polyester based on aliphatic and/or aromatic dicarboxylic acids and on aliphatic dihydroxy compounds; iv) from 0.1 to 2% by weight, based on the total weight of components i to iv, of a copolymer which comprises epoxy groups and which is based on styrene, acrylate, and/or methacrylate, and v) from 0.1 to 5% by weight, based on the total weight of components i to v, of a nucleating agent,
b) incorporation by mixing of vi) from 1 to 7% by weight, based on the total weight of components i to v, of an organic blowing agent and vii) from 0.01 to 5% by weight of a co-blowing agent—selected from the group of nitrogen, carbon dioxide, argon, helium, and mixtures thereof—into the polymer melt optionally by means of a static or dynamic mixer at a temperature of at least 140° C.,
c) discharging through a die plate with holes, the diameter of which at the exit from the die is at most 1.5 mm, and
d) pelletizing the melt comprising blowing agent directly downstream of the die plate, and under water, at a pressure in the range from 1 to 20 bar.

The use of volatile, liquid/gaseous co-blowing agents vii) which form cavities can establish a cellular structure in the expandable pelletized material, and this can be used to improve the subsequent foaming procedure and to control cell size.

Suitable nucleating agents v) and blowing agents vi) are the agents described above.

The process for establishing said cavity morphology can also be termed prenucleation, where the cavities are in essence formed by the co-blowing agent vii).

The co-blowing agent vii) which forms the cavities differs from the actual blowing agent vi in its solubility in the polymer. During the production process, firstly blowing agent vi) and co-blowing agent vii) are completely dissolved in the polymer at adequately high pressure. The pressure is then reduced, preferably within a short time, and the solubility of the co-blowing agent vii) is thus reduced. Phase separation therefore occurs in the polymeric matrix, and a prenucleated structure is produced. The actual blowing agent vi) remains predominantly dissolved in the polymer, because of its higher solubility and/or low diffusion rate. It is preferable that a temperature reduction is implemented simultaneously with the pressure reduction, in order to inhibit excessive nucleation of the system and to reduce the extent of diffusion of the actual blowing agent vi) out of the system. This is achieved via co-blowing agent vii) in conjunction with ideal pelletization conditions.

It is preferable that at least 80% by weight of the co-blowing agent vii) escapes within a period of 24 h when the expandable thermoplastic beads are stored at 25° C., atmospheric pressure, and 50% relative humidity. The solubility of the co-blowing agent vii) in the expandable thermoplastic beads is preferably below 0.1% by weight.

In all cases, the amount added of the co-blowing agent vii) used in the prenucleation process should exceed the maximum solubility under the prevailing process conditions. It is therefore preferable to use co-blowing agents vii) which have low, but adequate, solubility in the polymer. Among these are in particular gases, such as nitrogen, carbon dioxide, air, or noble gases, particularly preferably nitrogen, the solubility of which in many polymers decreases at low temperatures and pressures. However, it is also possible to use other liquid additives.

It is particularly preferable to use inert gases, such as nitrogen and carbon dioxide. Both gases feature not only suitable physical properties but also low cost, good availability, easy handling, and unreactive or inert behavior. In almost all cases, by way of example, no degradation of the polymer takes place in the presence of either gas. The gases themselves can be obtained from the atmosphere, and they therefore also have no effect on the environment.

The amount used here of the co-blowing agent vii) should: (a) be sufficiently small to dissolve at the prevailing melt temperatures and prevailing melt pressures during the melt-impregnation process extending as far as pelletization; (b) be sufficiently high to give demixing from the polymer at the water pressure of the pelletization process and at the temperature of the pelletization, and to give nucleation. In one preferred embodiment, at least one of the blowing agents used is gaseous at room temperature and atmospheric pressure.

It is particularly preferable to use talc as nucleating agent v) in combination with nitrogen as co-blowing agent vii).

The expandable pelletized materials can be transported and stored by using, inter alia, metal drums and octabins. If drums are used, it should be noted that release of the co-blowing agents vii) can sometimes increase the pressure in the drum. Packaging preferably used is therefore open packs, such as octabins or drums where these permit depressurization via permeation of the gas out of the drum. Particular preference is given here to drums which permit diffusion of the co-blowing agent vii) out of the drum but which minimize or prevent diffusion of the actual blowing agent vi) out of the drum. This is possible by way of example by selecting the sealing material so that it is appropriate to the blowing agent and, respectively, co-blowing agent vii). The permeability of the sealing material to the co-blowing agent vii) is preferably higher by a factor of at least 20 than the permeability of the sealing material to the blowing agent vi).

The prenucleation process, for example via addition of small amounts of nitrogen and carbon dioxide, can establish a cellular morphology in the expandable, pelletized material comprising blowing agent. The average cell size in the center of the beads here can be greater than in the peripheral regions, and the density of the beads can be higher in the peripheral regions. Blowing agent losses are thus minimized.

The prenucleation process can achieve markedly better cell size distribution and reduced cell size after the prefoaming process. Furthermore, the amount of blowing agent needed to achieve a minimal bulk density is smaller, and the material has better storage stability. Small amounts of nitrogen or carbon dioxide added to the melt can give markedly shorter prefoaming times at constant blowing agent content or markedly reduced amounts of blowing agent for identical foaming times and for minimal foam densities. The prenucleation process moreover improves product homogeneity and process stability.

Re-impregnation of the pelletized polymer materials of the invention with blowing agents is moreover possible markedly more rapidly than with pelletized materials which have identical constitution but compact, i.e. non-cellular, structure. On the one hand, the diffusion times are smaller, and on the other hand the amounts of blowing agent needed for the foaming process are smaller, by analogy with directly impregnated systems.

Finally, the prenucleation process can reduce the blowing agent content required to achieve a certain density, and can thus reduce the demolding times during molding production or slab production. Costs of further processing can thus be reduced and product quality can thus be improved.

The principle of the prenucleation process can be utilized not only for suspension technology but also for melt impregnation technology, for producing expandable beads. Preference is given to the application in the melt extrusion process, where the addition of the co-blowing agents vii) with the blowing agents vi) takes place in step b and finally pelletization is carried out via pressure-assisted underwater pelletization after discharge of the melt which has absorbed blowing agent. The microstructure of the pelletized material can be controlled as described above via selection of the pelletization parameters and of the co-blowing agent vii).

If amounts of co-blowing agent vii) are relatively high, for example in the range from 1 to 10% by weight, based on the polymer melt which comprises blowing agent, it is possible to lower the melt temperature or the melt viscosity and thus to achieve a marked increase in throughput. It is thus also possible to achieve incorporation of thermally labile additives to the polymer melt under non-aggressive conditions, examples being flame retardants. There is no resultant alteration to the constitution of the expandable thermoplastic beads, since the co-blowing agent in essence escapes during the melt extrusion process. This effect is preferably utilized by using CO₂. In the case of N₂, the effects on viscosity are smaller. Nitrogen is therefore predominantly used for establishing the desired cell structure.

The temperature at which the chamber comprising liquid is operated for the pelletization of the expandable thermoplastic polymer beads is preferably in the range from 20 to 80° C., particularly preferably in the range from 30 to 60° C.

In order to minimize thermal degradation of the polylactic acid it is moreover advantageous in all of the stages of the process to minimize the amount of mechanical and thermal energy introduced. The average shear rates in the screw channel should be small, and preference is given to maintenance of shear rates below 250/sec, preferably below 100/sec, and to temperatures below 260° C., and also to short residence times in the range from 2 to 10 minutes in stages c) and d). The residence times are generally from 1.5 to 4 minutes in the absence of a cooling step, and generally from 5 to 10 minutes if there is a cooling step provided. The polymer melt can be conveyed and discharged by using pressurizing pumps, e.g. gear pumps.

To improve processability, the finished expandable pelletized material can be coated with glycerol ester, with antistatic agents, or with anticaking agents.

The expandable pelletized material of the invention exhibits relatively little caking when compared with pelletized material which comprises low-molecular-weight plasticizers, and features low pentane loss during storage.

In a first step, hot air or steam can be used to prefoam the expandable pelletized material of the invention to give foam beads of density in the range from 8 to 100 kg/m³, and in a 2^{nd} step the material can be fused in a closed mold to give moldings composed of beads.

Surprisingly, the foam beads have markedly higher crystallinity than the expandable pelletized material. Crystallinity can be determined with the aid of small-angle X-ray scattering, abbreviated to SAXS. The crystalline content of the expandable pelletized material after the production process is generally only a few percent—the material therefore being predominantly amorphous—whereas the crystallinity of the foamed beads is markedly higher: from 8 to 40%, and, associated with this, they have markedly higher heat resistance.

The pelletized material produced by the process of the invention has high biodegradability together with good foaming properties.

For the purposes of the present invention, a substance or substance mixture complies with the “biodegradable” feature if said substance or substance mixture exhibits a percentage degree of biodegradation of at least 90% to DIN EN 13432. In particular, the moldable foams of the invention have high degradability under anaerobic conditions.

Biodegradability generally leads to decomposition of the pelletized material or foams produced therefrom in an appropriate and demonstrable period of time. The degradation can take place by an enzymatic, hydrolytic, or oxidative route, and/or via exposure to electromagnetic radiation, such as UV radiation, and can mostly be brought about predominantly via exposure to microorganisms, such as bacteria, yeasts, fungi, and algae. Biodegradability can be quantified by way of example by mixing polyester with compost and storing it for a particular period. By way of example, according to DIN EN 13432, CO₂-free air is passed through ripened compost during the composting process, and the compost is subjected to a defined temperature profile. The biodegradability here is defined as a percentage degree of biodegradation by taking the ratio of the net amount of CO₂ released from the specimen (after subtraction of the amount of CO₂ released by the compost without specimen) to the maximum amount of CO₂ that can be released from the specimen (calculated from the carbon content of the specimen). Biodegradable pelletized material generally exhibits marked signs of degradation after just a few days of composting, examples being fungal growth, cracking, and perforation.

Other methods for determining biodegradability are described by way of example in ASTM D5338 and ASTM D6400-4.

### EXAMPLES

### Materials Used:

### Component i:

i-1: Aliphatic polyester, Natureworks® 8051D polylactide from NatureWorks.

### Component ii:

ii-1: Poly-3-hydroxybutyrat-co-3-hydroxyhexanoate having 11% of hexanoate comonomer content from Kaneka (trademark Aonilex).

### Component iii:

iii-1: To produce the polyester ii-2, 14.89 kg of sebacic acid, 165.18 kg of succinic acid, 172.5 kg of 1,4-butanediol, and 0.66 kg of glycerol were mixed together with 0.031 kg of tetrabutyl orthotitanate (TBOT) in a 450 liter polycondensation tank, where the molar ratio between alcohol components and acid component was 1.30. The reaction mixture was heated to an internal temperature of 200° C. while water was removed by distillation, and it was kept at said temperature for 1 h. The temperature was then increased to an internal temperature of about 250-260° C., and at the same time the excess 1,4-butanediol was removed by distillation in vacuo (final vacuum about 3-20 mbar). The polycondensation process was terminated by cooling to about 180-200° C. once the desired final viscosity had been reached, and the prepolyester was chain-extended with 1.5 kg of hexamethylene diisocyanate for 1 h at 240° C., and pelletized.
   The molar mass (Mn) of the resultant polyester iii-1 was 37 000 g/mol.

### Component iv:

iv-1: Joncryl® ADR 4368 CS from BASF SE.

### Component v:

v-1: Chinatalc HP 325 from Luzenac

### Component vi:

vi-1: Blowing agent: isopentane

### Component vii:

vii-1: Co-blowing agent: nitrogen (N₂)

The proportions correspond to % by weight and are based on 100% by weight of polymer (components i to v)

### Inventive Example 1

4.9 parts of isopentane (component vi-1) and 0.1 part of nitrogen (vii-1) were incorporated by mixing into a melt made of 89.3 parts of component i-1, 10 parts of component ii-1, 0.3 part of component iv-1 and 0.4 part of component v-1 at a melt temperature of 160-240° C.

The melt was conveyed at throughput 4.5 kg/h through a die plate with one hole (diameter 0.65 mm). Compact (incipiently nucleated/prenucleated) pelletized material with narrow size distribution was produced with the aid of pressurized (15 bar) underwater pelletization. Average particle size was 1.4 mm, and the density of the expandable pelletized material was 680 kg/m³.

A stream of steam was used to prefoam the pelletized material. The density of the foamed beads of pelletized material was 36 kg/m³. The minimal bulk density of the foamed beads of pelletized material was still 53 kg/m³ after 13 weeks.

### Inventive Example 2

4.9 parts of isopentane (component vi-1) and 0.1 part of nitrogen (vii-1) were incorporated by mixing into a melt made of 79.3 parts of component i-1, 20 parts of component ii-1, 0.3 part of component iv-1 and 0.4 part of component v-1 at a melt temperature of 160-240° C.

The melt was conveyed at throughput 4.5 kg/h through a die plate with one hole (diameter 0.65 mm). Compact (incipiently nucleated/prenucleated) pelletized material with narrow size distribution was produced with the aid of pressurized (15 bar) underwater pelletization. Average particle size was 1.4 mm, and the density of the expandable pelletized material was 695 kg/m³.

A stream of steam was used to prefoam the pelletized material. The density of the foamed beads of pelletized material was 53 kg/m³. The minimal bulk density of the foamed beads of pelletized material was still 68 kg/m³ after 13 weeks.

### Inventive Example 3

4.9 parts of isopentane (component vi-1) and 0.1 part of nitrogen (vii-1) were incorporated by mixing into a melt made of 69.3 parts of component i-1, 30 parts of component ii-1, 0.3 part of component iv-1 and 0.4 part of component v-1 at a melt temperature of 160-240° C.

The melt was conveyed at throughput 4.5 kg/h through a die plate with one hole (diameter 0.65 mm). Compact (incipiently nucleated/prenucleated) pelletized material with narrow size distribution was produced with the aid of pressurized (15 bar) underwater pelletization. Average particle size was 1.4 mm, and the density of the expandable pelletized material was 725 kg/m³.

A stream of steam was used to prefoam the pelletized material. The density of the foamed beads of pelletized material was 65 kg/m^{s}. The minimal bulk density of the foamed beads of pelletized material was still 85 kg/m³ after 13 weeks.

### Inventive Example 4

4.9 parts of isopentane (component vi-1) and 0.1 part of nitrogen (vii-1) were incorporated by mixing into a melt made of 59.3 parts of component i-1, 30 parts of component ii-1, 10 parts of component iii-1, 0.3 part of component iv-1 and 0.4 part of component v-1 at a melt temperature of 160-240° C.

The melt was conveyed at throughput 4.5 kg/h through a die plate with one hole (diameter 0.65 mm). Compact (incipiently nucleated/prenucleated) pelletized material with narrow size distribution was produced with the aid of pressurized (15 bar) underwater pelletization. Average particle size was 1.4 mm, and the density of the expandable pelletized material was 750 kg/m³.

A stream of steam was used to prefoam the pelletized material. The density of the foamed beads of pelletized material was 140 kg/m³. The minimal bulk density of the foamed beads of pelletized material was still 286 kg/m³ after 13 weeks.

### Inventive Example 5

4.9 parts of isopentane (component vi-1) and 0.1 part of nitrogen (vii-1) were incorporated by mixing into a melt made of 59.3 parts of component i-1, 40 parts of component ii-1, 0.3 part of component iv-1 and 0.4 part of component v-1 at a melt temperature of 160-240° C.

The melt was conveyed at throughput 4.5 kg/h through a die plate with one hole (diameter 0.65 mm). Compact (incipiently nucleated/prenucleated) pelletized material with narrow size distribution was produced with the aid of pressurized (15 bar) underwater pelletization. Average particle size was 1.4 mm, and the density of the expandable pelletized material was 745 kg/m³.

A stream of steam was used to prefoam the pelletized material. The density of the foamed beads of pelletized material was 218 kg/m³. The minimal bulk density of the foamed beads of pelletized material was still 551 kg/m³ after 13 weeks.

TABLE 1

| | | | | Inv. ex-4 | |
|---|---|---|---|---|---|
| | Inv. ex-1 | Inv. ex-2 | Inv. ex-3 | PLA/PHBH/ | Comp. ex-5 |
| | PLA/PHBH | PLA/PHBH | PLA/PHBH | PBSSe | PLA/PHBH |
| Component i-1 | 89.3 | 79.3 | 69.3 | 59.3 | 59.3 |
| Component ii-1 | 10 | 20 | 30 | 30 | 40 |
| Component iii-1 | 0 | 0 | 0 | 10 | 0 |
| Component iv-1 | 0.3 | 0.3 | 0.3 | 0.3 | 0.3 |
| Component v-1 | 0.4 | 0.4 | 0.4 | 0.4 | 0.4 |
| Component vi-1 | 4.9 | 4.9 | 4.9 | 4.9 | 4.9 |
| Component vii-1 | 0.1 | 0.1 | 0.1 | 0.1 | 0.1 |
| Minimal bulk | 680 | 695 | 725 | 750 | 745 |
| density of pelletized | | | | | |
| material (kg/m³) | | | | | |
| Minimal bulk density | 36 | 53 | 65 | 140 | 218 |
| of foam, directly after | | | | | |
| production (kg/m³) | | | | | |
| Minimal bulk density | 53 | 68 | 85 | 286 | 551 |
| of foam after 13 weeks | | | | | |
| (kg/m³) | | | | | |

The results in Table 1 clearly show that as polyhydroxyalkanoate content rises the crystallinity of expandable pelletized material, and in particular also of the foamed beads of pelletized material, rises.

If polyhydroxyalkanoate content is too high (component ii above 30% by weight), it becomes impossible to produce any low-density foamed beads of pelletized material (see comparative example 5). Surprisingly, this effect is less marked when polymers are used which comprise polylactic acid and which also comprise from 1 to 29.9% by weight of an aliphatic or semiaromatic polyester (component iii) (inventive example 4) than when a polymer is used which comprises polylactic acid and comprises no component iii.

TABLE 2
Crystallinity measured by means of SAXS

| | Crystallinity of | Crystallinity of |
|---|---|---|
| | pelletized material (%) | foam bead (%) |
| Inv. ex-1 | 1 | 8 |
| Inv. ex-4 | 13 | 17 |
| Comp. ex-5 | 17 | 18 |

1-11. (canceled)

12. A process for producing expandable pelletized material which comprises polylactic acid which comprises the following steps:
a) melting and incorporation by mixing of the following components:
i) from 61.9 to 98.9% by weight, based on the total weight of components i to iv, of polylactic acid,
ii) from 1 to 38% by weight, based on the total weight of components i to iv, of at least one polyhydroxyalkanoate,
iii) from 0 to 30% by weight, based on the total weight of components i to iv, of at least one polyester based on aliphatic and/or aromatic dicarboxylic acids and on aliphatic dihydroxy compounds;
iv) from 0.1 to 2% by weight, based on the total weight of components i to iv, of a copolymer which comprises epoxy groups and which is based on styrene, acrylate, and/or methacrylate, and
v) from 0 to 10% by weight, based on the total weight of components i to v, of one or more additives,
b) incorporation by mixing of vi) from 3 to 7% by weight, based on the total weight of components i to v, of an organic blowing agent into the polymer melt by means of a static or dynamic mixer at a temperature of at least 140° C.,
c) discharging through a die plate with holes, the diameter of which at the exit from the die is at most 1.5 mm, and
d) pelletizing the melt comprising blowing agent directly downstream of the die plate, and under water, at a pressure in the range from 1 to 30 bar.

13. The process according to claim 12, wherein component i) used in step a) comprises polylactic acid with MVR of from 5 to 8 ml/10 minutes to ISO 1133 [190° C./2.16 kg].

14. The process according to claim 12, wherein component ii) used in step a) comprises a poly(3-hydroxybutyrate-co-3-hydroxyhexanoate) or a poly(3-hydroxybutyrate-co-4-hydroxybutyrate).

15. The process according to claim 12, wherein the organic blowing agent used in step b) comprises isopentane.

16. The process according to claim 12, wherein the underwater pelletization process is carried out at a temperature of from 5 to 20° C.

17. A process for producing expandable pelletized material which comprises polylactic acid, which comprises the following steps:
a) melting and incorporation by mixing of the following components:
i) 61.9 to 98.9% by weight, based on the total weight of components i to iv, of polylactic acid,
ii) from 1 to 38% by weight, based on the total weight of components i to iv, of at least one polyhydroxyalkanoate,
iii) from 0 to 30% by weight, based on the total weight of components i to iv, of at least one polyester based on aliphatic and/or aromatic dicarboxylic acids and on aliphatic dihydroxy compounds;
iv) from 0.1 to 2% by weight, based on the total weight of components i to iv, of a copolymer which comprises epoxy groups and which is based on styrene, acrylate, and/or methacrylate, and
v) from 0.1 to 5% by weight, based on the total weight of components i to v, of a nucleating agent,
b) incorporation by mixing of vi) from 1 to 7% by weight, based on the total weight of components i to v, of an organic blowing agent and vii) from 0.01 to 5% by weight of a co-blowing agent—selected from the group of nitrogen, carbon dioxide, argon, helium and mixtures thereof—into the polymer melt by means of a static or dynamic mixer at a temperature of at least 140° C.,
c) discharging through a die plate with holes, the diameter of which at the exit from the die is at most 1.5 mm, and
d) pelletizing the melt comprising blowing agent directly downstream of the die plate, and underwater, at a pressure in the range from 1 to 30 bar.

18. The process according to claim 17, wherein the underwater pelletization process is carried out at from 20 to 80° C.

19. An expandable pelletized material which comprises polylactic acid, according to claim 16, which has a bulk density in the range from 580 to 800 kg/m3.

20. An expandable pelletized material which comprises polylactic acid and which has a solids content of from 93 to 97% by weight, comprising:
i) from 61.9 to 98.9% by weight, based on the total weight of components i to iv, of polylactic acid,
ii) from 1 to 38% by weight, based on the total weight of components i to iv, of at least one polyhydroxyalkanoate,
iii) from 0 to 30% by weight, based on the total weight of components i to iv, of at least one polyester based on aliphatic and/or aromatic dicarboxylic acids and on aliphatic dihydroxy compounds,
iv) from 0.1 to 2% by weight, based on the total weight of components i to iv, of a copolymer which comprises epoxy groups and which is based on styrene, acrylate, and/or methacrylate, and
v) from 0 to 10% by weight, based on the total weight of components i to v, of one or more additives;
vi) and a proportion of from 3 to 7% by weight, based on the total weight of components to v, of an organic blowing agent.

21. A process for producing moldable-foam moldings, which comprises using hot air or steam in a first step to prefoam the expandable pelletized material according to claim 19, to give foam beads of density in the range from 8 to 100 kg/m³, and, in a second step, fusing the materials in a closed mold.

22. A process for producing a casings for meat, for soups, or for producing drinking cups, agricultural items, food- or drinks-packaging, or electrical items, or for insulation in the construction industry, or for shock absorption and sound-deadening which comprises utilizing the expandable pelletized material according to claim 19.
